(19) United States
(12) Patent Application Publication
(10) Pub. No.: US 2002/0007405 A1
(43) Pub. Date: Jan. 17, 2002

(54) Data importer

(76) Inventor: Mushtaq Bahadur, North Sydney (AU)

Correspondence Address: Roger N. Chauza, HOWISON, CHAUZA, THOMA, HANDLEY & ARNOTT, L.L.P., P.O. Box 741715, Dallas, TX, 75374-1715, US

(21) Appl. No.: 09/808,460

(22) Filed: Mar. 14, 2001

(30) Foreign Application Priority Data
Mar. 15, 2000 (AU) PQ 6307

(51) Int. Cl. G06F 15/16

(52) U.S. Cl. 709/218; 709/219; 709/227

(57) ABSTRACT

This invention facilitates the importation of data from external systems. In particular, the importation of data from XML files is employed. In a first aspect, the invention concerns a method for importing data, in a second aspect the invention concerns a computer system for importing data, and in a further aspect the invention relates to a computer program. The invention involves specifying an XML file to be imported, uploading the specified XML file, and parsing the file to provide programmatic access to the structure and content of the data being imported. For instance, a parsing servlet creates a series of values for graphically representing the structure of the data. The data and metadata values may then be stored in tables and made available to data-driven applications.

### TECHNICAL FIELD

This invention concerns the importation of data from external systems. In particular, the present invention concerns the importation of data from XML files. In a first aspect, the invention concerns a method for importing data, in a second aspect it concerns a computer system for importing data, and in a further aspect it concerns a computer program.

### SUMMARY OF THE INVENTION

In accordance with a first aspect, the invention relates to a method for importing data from XML files, comprising the steps of:

specifying an XML file to be imported,

uploading the specified XML file,

parsing the file to provide programmatic access to the structure and content of the data being imported; for instance into a series of values for graphically representing the structure of the data, such as nodes of an information Document Object Model (DOM) tree, and

storing the metadata and data values in tables.

If necessary, the values are corrected by a user inspecting the tree, into a format suitable for passing to the information tree. The tree may be viewed by a user for this purpose.

The storage may consist of four tables, i.e., ww_form-temp (metadata), ww_form_item_temp (metadata), ww_files_temp (data), and ww_objects_temp (data).

The invention may be used to import and then view information from external systems. In an elementary implementation, an XML file may be imported without a Document Type Definition (DTD). Alternatively, in a more complex scenario, the attributes of a corresponding DTD may be applied along with the presentation layer provided by XSL.

The information may be imported in batch or real-time mode from an external system such as Oracle Financials, SAP or Peoplesoft.

The imported information may be integrated with other systems without any code changes.

In another aspect, the invention relates to a computer system for importing data from XML files, comprising in data storage:

an Upload Servlet to upload a specified XML file,

a Parsing Servlet to provide programmatic access to the structure and content of the data being imported; for instance into a series of values for graphically representing the structure of the data. For instance each node of an information (DOM) tree, and

a Saving Servlet to save the data and metadata values of the tree to storage.

In a further aspect, the invention is a computer program, comprising:

an Upload Servlet to upload a specified XML file,

a Parsing Servlet to provide programmatic access to the structure and content of the data being imported; for instance into a series of values for graphically representing the structure of the data. For instance each node of an information (DOM) tree, and

a Saving Servlet to save the data and metadata values of the tree to storage.

### BRIEF DESCRIPTION OF THE DRAWINGS

An example of the invention will now be described with reference to the accompanying drawings, in which:

FIG. 1 is a flow chart showing the importation process;

FIG. 2 is a table showing the effect of parsing an XML file;

FIG. 3 is a table showing the structure of temporary storage tables;

FIG. 4 is a representation of forms that have been identified; and

FIG. 5 is a representation of documents that could be produced.

### DETAILED DESCRIPTION OF THE INVENTION

Setting up an importation interface involves installing server side utilities as well as a once-off client side modification. The modifications needed on the client side are simply a matter of installing the Java Runtime Environment 1.2.2 (JRE), which includes appropriate plug-ins for both Netscape Navigator 4.6+ (Navigator) and Internet Explorer 5+ (IE5). Once this set up is accomplished, all Java 1.2.2 applets will run in IE5 and Navigator.

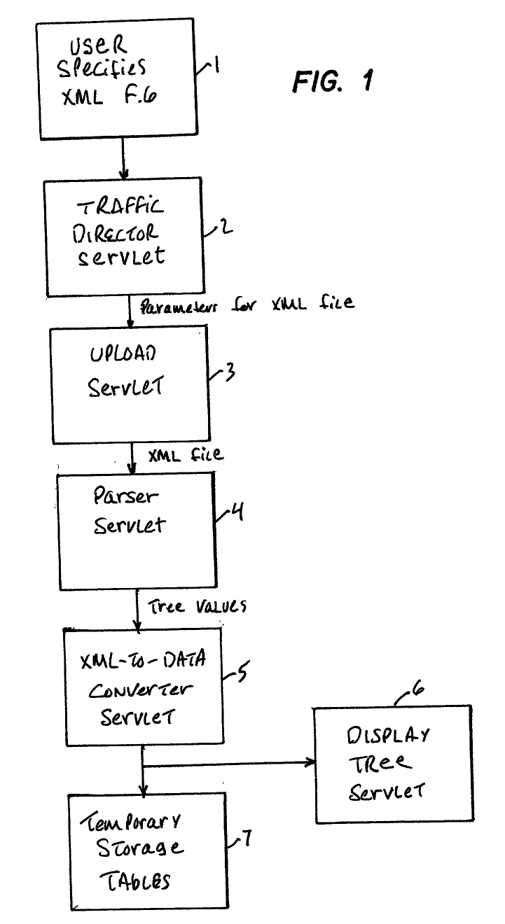

Referring now to FIG. 1, the importation process 1 is initiated by a user calling a TrafficDirector Servlet 2 and specifying the XML file to be imported. This will typically require typing in the host address, port number and database driver to be employed. A username and password may be required to satisfy the login credentials for the external database. The TrafficDirector Servlet 2 then calls an Upload Servlet 3 and provides it with the appropriate parameters.

Once login to the external source has been achieved, then the hostname and database name will appear, and a list of all the accessible tables will also be created, along with a list of all accessible columns from the selected table. This is the table from which the data is retrieved.

To limit the values which are available for selection, the user can create a criteria to determine which values will be available.

An XML document usually includes or contains a reference to a Document Type Definition (DTD). Essentially a DTD defines the grammar for a class of documents, that is, it contains markup declarations that describe the logical structure of the documents and the constraints within the logical structure. An example of a DTD and a valid XML document written to this DTD is as follows. This example will be referred to throughout the remainder of this document:

### Document Type Definition

<!ELEMENT orderlist (order*)>
<!ELEMENT order (datetime,notes,salesperson, customer, part*)>
<!ATTLIST order id ID #REQUIRED>
<!ELEMENT datetime (#PCDATA)>
<!ELEMENT notes (#PCDATA)>
<!ELEMENT salesperson (name,department,phone)>
<!ATTLIST salesperson id ID #REQUIRED>
<!ELEMENT customer (name,address,phone)>
<!ATTLIST customer id ID #IMPLIED>
<!ELEMENT part (name,quantity,price)>
<!ATTLIST part id ID #REQUIRED>
<!ELEMENT name (#PCDATA)>
<!ELEMENT department (#PCDATA)>
<!ELEMENT phone (#PCDATA)>
<!ELEMENT address (#PCDATA)>
<!ELEMENT quantity (#PCDATA)>
<!ELEMENT price (#PCDATA)>

### Sample XML Document

<?xml version=“1.0” emcoding=“iso-8859-1”?>

<!DOCTYPE orederlist SYSTEM “orederlist.dtd”>
<orderlist>

<order id=“_5449431”>

<datetime>Feb 1 2000 5:37PM</datetime>
<notes>We need to hurry this order through. . .</notes>
<salesperson id=“37”>
<name>Jill Smith</name>
<department>Sales</department>
<phone>90991234</phone>

</salesperson>
<customer id=”909921”>

<name>Bobs Plumbing</name>
<address>1 George St, Sydney, 2000</address>
<phone>90995678</phone>

</customer>
<part id=“10987”>

<name>Widget Flange</name>
<quantity>100</quantity>
<price>0.50</price>

</part>
<part id=“10990”>

<name>Widget Head Bolt</name>
<quantity>100</quantity>
<price>2.00</price>

</part>

</order>
<order id=“_5449432”>

<datetime>Feb 1 2000 5:37PM</datetime>
<notes>Take your time,
this customer still hasn't paid last invoice.</notes>
<salesperson id=“41”>

<name>John Sparky</name>
<department>Sales</department>
<phone>90991235</phone>

</salesperson>
<customer id=“909989”>

<name>Kens Hardware</name>
<address>99 Ken St., Sydney, 2000</address>
<phone>90999101</phone>

</customer>
<part id=“10969”>

<name>Widget Rubber Seal</name>
<quantity>200</quantity>
<price>0.25</price>

</part>
<part id=“10899”>

<name>Widget Spring</name>
<quantity>10</quantity>
<price>4.00</price>

</part>

</order>

</orderlist>

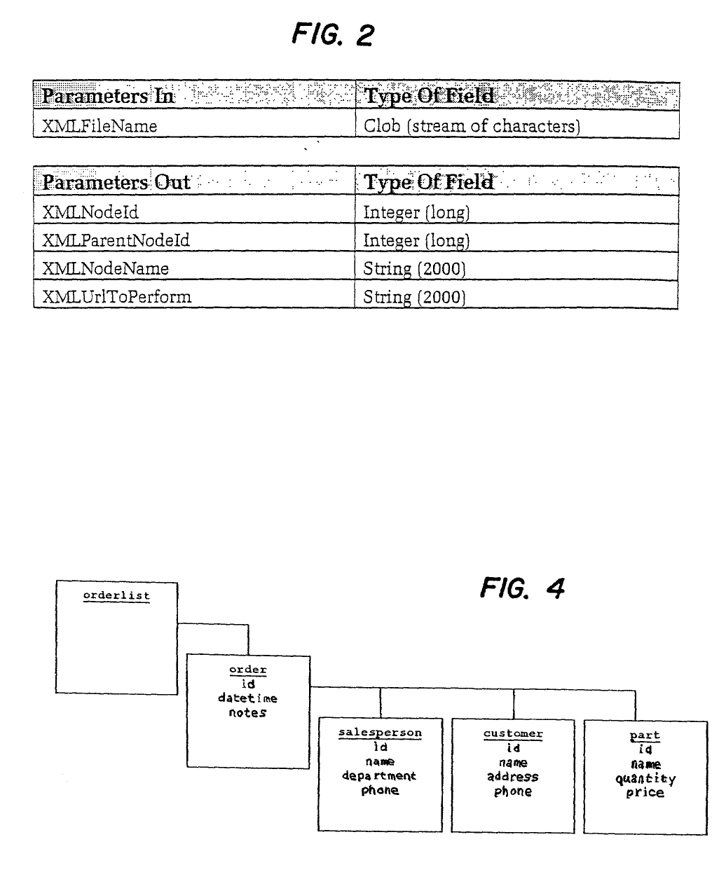

The Upload Servlet 3 uploads the specified XML file and calls a Parser Servlet 4 which reads the file and deciphers it to produce a Document Object Model (as defined by W3C). The Document Object Model (DOM) provides programmatic access to the structure and content of the data being imported. In practice, this means converting it into a series of values representing each node of an information (DOM) tree; as shown in FIG. 2.

The values are then passed to an XML-To-Data Converter Servlet 5 which ensures the values retrieved from the Parser 4 are in the correct format to pass to the information tree. The tree may then be viewed by the user using a Display Tree Servlet 6.

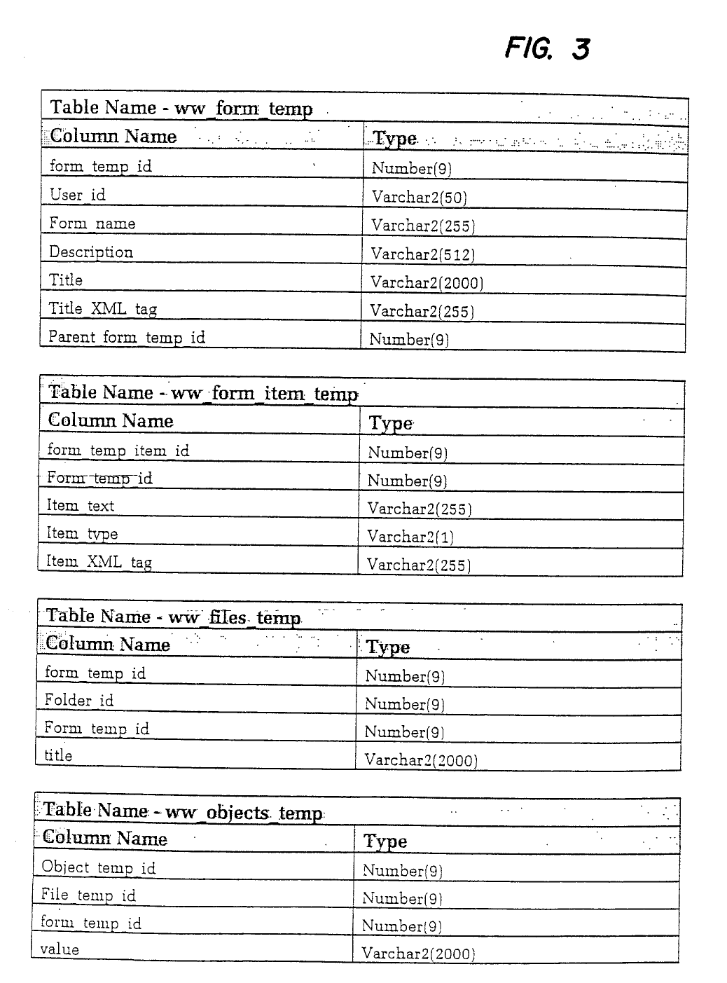

If the tree is to be saved, it is written to temporary storage 7. The temporary storage areas basically consist of four tables, i.e., ww_form_temp (metadata), ww_form_item_temp (metadata), ww_files_temp (data), and ww objects temp (data). The table structure is shown in FIG. 3.

Upon saving the XML tree, the metadata and data values are stored. The relationship between parent-child and individual fields on a form is elementary. All tags that appear at the same tree level are fields on the same form. If a tag is identified, then it has a parent node.

Once an XML document has been received from an external source it can be fed into a data driven application comprised of:

Metadata—The forms (templates) required to publish content;

A Home—The folders defined to hold the published content;

Search Facilities—Automatic access to search facilities specifically tailored for the structure of the content published;

Content—The published content; and

Workflow—A workflow process to direct published content.

This task involves the following steps:

1. Create new metadata (Form templates) by analyzing the structure of the DOM.

Given that the XML data is hierarchical in structure, the metadata produced will also be hierarchical, that is, the forms will be built on parent/child relationships. Identifying the documentary forms required involves a traversal of the DOM tree using the following criteria:

start with the root node;

any node with only a single value becomes a new field on the current form; and

any node with more than one child (the value of a node is represented as a child) requires a new form, a child form.

This process is recursive as the DOM structure is traversed:

begin

node = getRootNode
createForm(node)

end
sub createForm(node)
begin

for each child of this node
if child node has more than one child of it's own

newForm = createForm(child)
thisForm.addChild(newForm)

else

newField = createField(child)
thisForm.addField(newField)

endif

endfor

end

Given this process and the sample XML document presented, the forms shown in FIG. 4 can been identified:

2. Create a home for it and associated workflow.

The home is essentially a folder structure in which each folder has a defined purpose. A home for the sample imported appears as follows:

Widget Orders Folders

All Folder—A folder contains all of the content published,

Search Folder—A means of accessing the automatic search facility for this content, and

Publish Folder—This folder contains the form required to publish the new content.

In order to publish the folder content, a workflow process is also defined. At its simplest, the workflow for the content imported from an external XML source is ‘direct to repository’. That is, given generic XML it is possible to identify an individual or individuals for the workflow process.

3. Populate it with content extracted from the DOM using the metadata defined in step 1.

“Populating” means building a set of documents from the XML content imported, based on the forms defined in step 1.

Unlike the process of creating the metadata (the forms), which was driven by the structure of the DOM, this process is driven by the structure of the new forms.

Again, this process is recursive as the form structure is traversed:

begin

node = getRootNode
form = getParentForm
createDocument(node, form)

end
sub createDocument(node, form)
begin

for each field in this form

get all children of current node that have same name as
form field for each child node

newDocField = createDocField(childnode, formfield)
thisDocument.addField(newDocField)

endfor

endfor
for each child form of the current form

get all children of current node that have same name as
child form for each child node

newDocument = createDocument(childnode,
childform)
thisDocument.addChild(newDocument)

endfor

endfor

end

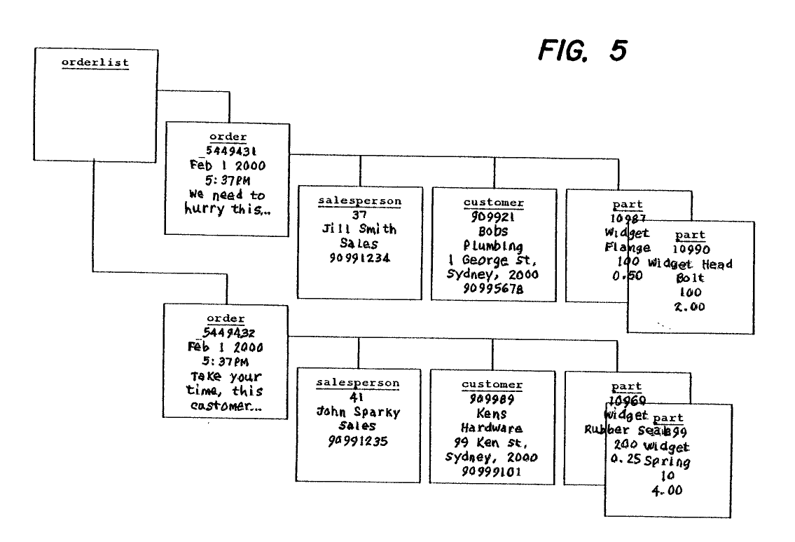

Given this process, and the sample XML document, the documents shown in FIG. 5 would be produced.

Having created the building blocks, it remains to map the objects created to an underlying relational database.

It will be appreciated by persons skilled in the art that numerous variations and/or modifications may be made to the invention as shown in the specific embodiments, without departing from the spirit or scope of the invention as broadly described. The present embodiments are, therefore, to be considered in all respects as illustrative and not restrictive.

What is claimed is:

1. A method for importing data from XML files, comprising the steps of:
specifying an XML file to be imported;
uploading the specified XML file;
parsing the XML file to provide programmatic access to a structure and content of data being imported; and
storing corresponding metadata and data values in tables.

2. A method for importing data according to claim 1, wherein the parsing step creates a document object model.

3. A method for importing data according to claim 2, wherein the parsing step creates a series of values for graphically representing the structure of the data.

4. A method for importing data according to claim 3, wherein the series of value comprises nodes of an information tree.

5. A method for importing data according to claim 4, further including displaying the information tree.

6. A method for importing data according to claim 5, further including inspecting the information tree, correcting the values, into a format suitable to pass to the information tree.

7. A method for importing data according to claim 1, wherein all tags that appear at a same tree level become fields on a form of the same type.

8. A method for importing data according to claim 1, wherein once an XML document has been received from an external source, the XML document is fed into a data driven application.

9. A method for importing data according to claim 8, wherein a conversion to a data driven application includes the steps:
creating new metadata which define respective forms; and
starting with a root node, and any node with only a single child becomes a new field on a current form, and any node with more than one child requires a new child form.

10. A method for importing data according to claim 9, further including creating a home for each form and associating workflows with the forms.

11. A method for importing data according to claim 10, further including populating each form with content from the imported XML files using the new metadata.

12. A method for importing data according to claim 11, wherein the step of populating the forms includes the following steps:
starting with the root node, and populating each field in the form with data from a corresponding location in the imported XML file.

13. A computer system for importing data from XML files, comprising in data storage:
an upload servlet to upload a specified XML file;
a parsing servlet to provide programmatic access to a structure and content of the uploaded data file; and
a storage servlet for saving the data and metadata values in tables.

14. A computer system according to claim 13, wherein the parsing servlet creates a document object model.

15. A computer system according to claim 14, wherein the parsing servlet is operative to create a series of values for graphically representing the structure of the data.

16. A computer system according to claim 15, wherein the series of value comprises the nodes of an information tree.

17. A computer system according to claim 16, further including in combination a monitor to display the information tree.

18. A computer system according to claim 17, further including data entry mean for correcting values by inspecting the information tree, into a format suitable to pass to the information tree.

19. A computer system according to claim 18, wherein all tags appearing at the same tree level become fields on a form of the same type.

20. A computer system according to claim 19, wherein once an XML document has been received from an external source, the XML document is fed into a data driven application.

21. A computer system according to claim 20, wherein the XML document is represented as forms in the data driven application, and each said form is associated with a workflow.

22. A computer program, comprising:
an upload servlet for uploading a specified XML file;
a parsing servlet for providing programmatic access to a structure and content of the uploaded data file; and
a storage servlet for saving the data and metadata values in tables.

23. A computer program according to claim 22, wherein the parsing servlet creates a document object model.

24. A computer program according to claim 23, wherein the parsing servlet creates a series of values for graphically representing the structure of the data.

25. A computer program according to claim 24, wherein the series of value comprises nodes of an information tree.

26. A computer program according to claim 25, wherein all tags that appear at a same tree level become fields on a form of the same type.
